(19) United States
(12) Patent Application Publication
(10) Pub. No.: US 2008/0060834 A1
(43) Pub. Date: Mar. 13, 2008

(54) Electrical feedthrough

(76) Inventors: Stefan ECK, Hoechstadt (DE); Boris Frauenstein, Herzogenaurach (DE); Erich Haas, Flachslanden (DE); Josef Teske, Hallstadt (DE)

Correspondence Address: DALINA LAW GROUP, P.C., 7910 IVANHOE AVE. #325, LA JOLLA, CA, 92037, US

(21) Appl. No.: 11/780,996

(22) Filed: Jul. 20, 2007

(30) Foreign Application Priority Data
Sep. 7, 2006 (DE) 10 2006 041 939.1

(51) Int. Cl. H01B 17/26

(52) U.S. Cl. 174/152 GM; 607/37

(57) ABSTRACT

The present invention relates to an electrical bushing to be inserted into an opening of an implantable electrical treatment device having an electrically insulating insulation body, through which at least one electrically conductive terminal pin passes, which is connected hermetically sealed to the insulation body using a solder, the soldering material being glass or glass ceramic.

This application takes priority from German Patent Application DE 10 2006 041 939.1 filed 7 Sep. 2006, the specification of which is hereby incorporated herein by reference

### BACKGROUND OF THE INVENTION

1. Field of the Invention

The present invention relates to an electrical feed through to be inserted into an opening of an implantable electrical treatment device. Such electrical treatment devices are, for example, implantable cardiac pacemakers, implantable cardioverters/defibrillators, or cochlear implants

2. Description of the Related Art

The electrical feed through has an electrically insulating insulation body, through which at least one electrically conductive terminal pin passes, which is connected to the insulation body hermetically sealed.

Electrical feed through of this type are used for the purpose of producing an electrical connection between a hermetically sealed interior of a treatment device and the exterior of the treatment device. In known electrotherapy devices, such as cardiac pacemakers or cardioverters/defibrillators, a hermetically sealed metal housing is typically provided, which has a terminal body, also called a header, on one side, which carries terminal sockets for connecting electrode lines. The terminal sockets have electrical contacts which are used for the purpose of electrically connecting electrode lines to the control electronics in the interior of the housing of the cardiac pacemaker. A bushing, which is inserted hermetically sealed into a corresponding housing opening, is typically provided where the electrical connection enters the housing of the cardiac pacemaker.

Electrical feed through of this type are frequently implemented as filter bushings. In this case, the apparatuses carry an electrical filter against high-frequency electromagnetic radiation, so that corresponding signals are fed, if at all, only strongly damped to the control electronics in the interior of the housing and the control electronics first experience interference at significantly greater signal strengths of the electrical interference than would be the case without the electrical filter. A low-pass filter of this type is typically formed by a filter body which is connected like a capacitor between a device ground and a particular electrical line passing through the bushing.

Such an electrical line passing through the bushing is typically formed by an electrically conductive terminal pin, which passes through a through opening in an electrically insulating insulation body. The electrically conductive terminal pin projects on both sides beyond the particular face of the insulation body, so that on both sides of the insulation body—and thus on both sides of the electrical bushing—continuing electrical lines may be connected to the terminal pin in each case—by soldering or welding, for example. A possible gap between a through opening in the insulation body, through which a particular terminal pin passes, and the terminal pin itself is typically closed hermetically sealed using a solder, normally gold solder.

Manifold electrical bushings of this type are known from the prior art. Examples may be found in U.S. Pat. No. 6,934,582, U.S. Pat. No. 6,822,845, U.S. Pat. No. 6,765,780, U.S. Pat. No. 6,643,903, U.S. Pat. No. 6,567,259, U.S. Pat. No. 6,768,629, U.S. Pat. No. 6,765,779, U.S. Pat. No. 6,566,978, and U.S. Pat. No. 6,529,103.

In spite of the manifold known bushings, there is still the demand for improving them in regard to producibility and properties.

### BRIEF DESCRIPTION OF THE INVENTION

This object is achieved according to the present invention in that the insulation body is produced by sintering and at least one terminal pin is connected hermetically sealed to the insulation body by this sintering.

The terminal pin is thus incorporated directly into the insulation body by sintering during its production.

If, according to a preferred embodiment variation, the bushing has a flange, this flange may also be produced in the same sintering step with the insulation body and connected hermetically sealed together with the at least one terminal pin.

The advantage thus results that the number of components and process steps during the production are reduced and therefore the number of errors during production also decreases and the reliability of the bushing is increased.

A further important advantage is that conductive solder such as gold is not needed to connect the pin and flange hermetically sealed to the insulation body. Specifically, conductive solder such as gold solder requires at least two separate solder reservoirs, since otherwise an electrical short-circuit would occur between pin and flange. Therefore, an insulation body which is produced in a single sintering step and is simultaneously connected to pin and flange allows simpler and more compact constructions of electrical bushings.

A biocompatible surface of the insulation body on its exterior (in regard to the installed state) may also be achieved in this way without further measures.

The latter advantage is particularly provided if the insulation body comprises a ceramic material which preferably contains Al₂O₃. The insulation body particularly preferably comprises a glass-ceramic or glass-like material.

The insulation material may be coated on its surface in such a way that a biocompatible material, which preferably contains Al₂O₃, is located on its side facing toward the body.

The bushing is particularly suitable for high-voltage applications as a defibrillator if the insulation ceramic is shaped in such a way that long insulation distances result on the surface and in the volume. Suitable shapes are, for example, bulges and edges. Such shapes are preferably implemented on the side of the bushing facing toward the body.

In addition, shapes of this type offer stable anchoring possibilities for the header, so that its connection to the housing of the implant is more secure.

The terminal pin preferably comprises metal, which preferably contains platinum and particularly preferably is a platinum-iridium alloy. Iridium, niobium, tantalum, and titanium and their suitable alloys come into consideration as further, particularly biocompatible and corrosion-resistant metals for the pin. Terminal pins of this type have the desired biocompatibility, are corrosion resistant, and may be processed reliably.

To be suitable for treatment devices whose electrical components in the interior of the housing are to be connected via multiple electrical lines, for example, to one or more electrode lines, the bushing is preferably implemented as multipolar and has multiple terminal pins preferably running parallel to one another for this purpose.

In a preferred embodiment variant of a multipolar bushing, each pin has its separate insulation body, with the advantage that the insulation bodies may be implemented as rotationally symmetric, e.g., cylindrical, and are easily producible.

The connection of electrical lines of the header is made easier if the terminal pins have different lengths on the exterior of the bushing (in relation to the installed state). The connection of the electrical lines is also made easier in many cases if the pins are flattened, bent, or made in the shape of nail heads, or in other suitable shapes on their ends. However, terminal pins of equal length may also be provided in the installed state, however.

To achieve the greatest possible distance of the terminal pins from one another in an insulation body which is as small as possible, the terminal pins are situated uniformly distributed on a circular arc concentric to the insulation body, preferably running parallel to one another. Alternatively, however, the terminal pins may also be situated linearly in one plane in the insulation body. This may make further manufacturing steps in the pacemaker production easier. A linear configuration in which two or more rows of terminal pins are each situated offset to one another in the insulation body also comes into consideration.

In particular in the first of the three last-mentioned embodiment variants, it is advantageous if the circular body has a cross-sectional area running transversely to the longitudinal direction of the terminal pin(s), which is round and preferably circular.

The insulation body is preferably enclosed transversely to the longitudinal direction of the pins by a sleeve-like, metallic flange. The flange preferably comprises a material which is largely identical in its composition to the metallic housing of the treatment device. The flange is either worked out of a solid material by turning or milling, for example, or also itself produced by a suitable sintering process. In the latter case, the flange body may be penetrated by small pores, which do not impair the hermetic nature of the flange, however. A flange of this type may, for example, be connected hermetically sealed to a metallic housing of the treatment device by welding. According to a preferred embodiment variant, flange and insulation body are connected hermetically sealed to one another by sintering of the insulation body.

The bushing is preferably implemented as a filter bushing having a filter body. The filter body has disk-shaped capacitor electrodes running parallel to one another, which are alternately electrically connected to the flange and to a terminal pin.

In connection with the latter embodiment variant, the flange preferably extends far enough beyond the inner face of the insulation body that the flange also encloses the filter body over at least the majority of its length and in this way is easy to connect electrically to the capacitor electrodes of the filter body.

If the pins comprise iridium, niobium, tantalum, titanium, or similar materials which may not be soft-soldered directly, the electrically conductive connection of the pins to the capacitor electrodes of the filter body via electrically conductive adhesive or by soft soldering is made significantly easier if the pins are gilded using gold solder. The gilding may be restricted to the areas of the pins which are decisive for the electrical connection of the pins to the capacitor electrodes of the filter body.

In one variant, the capacitor electrodes of the filter body are soldered to the pins and the flange directly using gold solder, for example. A particularly heat-resistant filter body is required for this purpose. A filter bushing may be manufactured cost-effectively in a single, combined soldering/sintering step in this way. In this case, the application of gold or glass-ceramic solder may be dispensed with, instead, the insulation body is coated with iridium, niobium, titanium, tantalum, or their suitable alloys at suitable points for the soldering, for example.

To judge the hermetic seal of the implant interior to the environment formed by the bushing, it is advantageous if the areas of the sintered connections or soldered connections (using glass, glass-ceramic, or gold solder) are accessible for a helium leak test and are not concealed by a filter body and its electrically conductive connections to the pins and the flange. The ability to test the hermetic seal of the bushing may be ensured in multiple ways:
A through opening in the electrical filter body.
A through opening in one of the electrically conductive connections between the filter body and the pins and/or the flange.
The filter body is integrated in a socket which is connected via spot welds to the flange; the helium gas passage is ensured between the spot welds.
The electrical connection of the filter to the flange or to the pins is produced by a (spring) terminal, either the flange being shaped in such way that the springs are a component of the flange, or a separate spring body producing the electrical connection between the flange and the filter. The desired helium gas passage occurs in this case between the terminal points.

In one variant, the capacitor electrodes of the filter are already integrated in the insulation body, so that a separate filter body is dispensed with. A possible embodiment is that the same ceramic insulation material (Al₂O₃) is used as the dielectric material between the capacitor electrodes as on the surface. In a further embodiment variant, a material adapted for the electrical filter function (e.g., BaTiO₃ or a similar ceramic material of high permittivity) is located between the capacitor electrodes, while a biocompatible insulating material is located on the surface (e.g., Al₂O₃).

Finally, to ensure good mounting ability and a good seal between flange and insulation body, the insulation body preferably has a peripheral shoulder in the exterior peripheral surface, which works together with a corresponding shoulder in the inner wall of the flange when the two shoulders on the peripheral surface of the insulation body and in the inner wall of the flange run inclined in relation to the longitudinal direction of the feed through, so that conical surfaces working together with one another result, and the shoulder also makes centering the insulation body in relation to the flange easier.

### BRIEF DESCRIPTION OF THE DRAWINGS

The present invention will now be explained in greater detail on the basis of exemplary embodiments with reference to the drawings. In the figures:

FIG. 1: shows a sintered bushing in cross-section; and

FIG. 2: shows a cardiac pacemaker having a bushing according to the present invention.

### DETAILED DESCRIPTION OF THE INVENTION

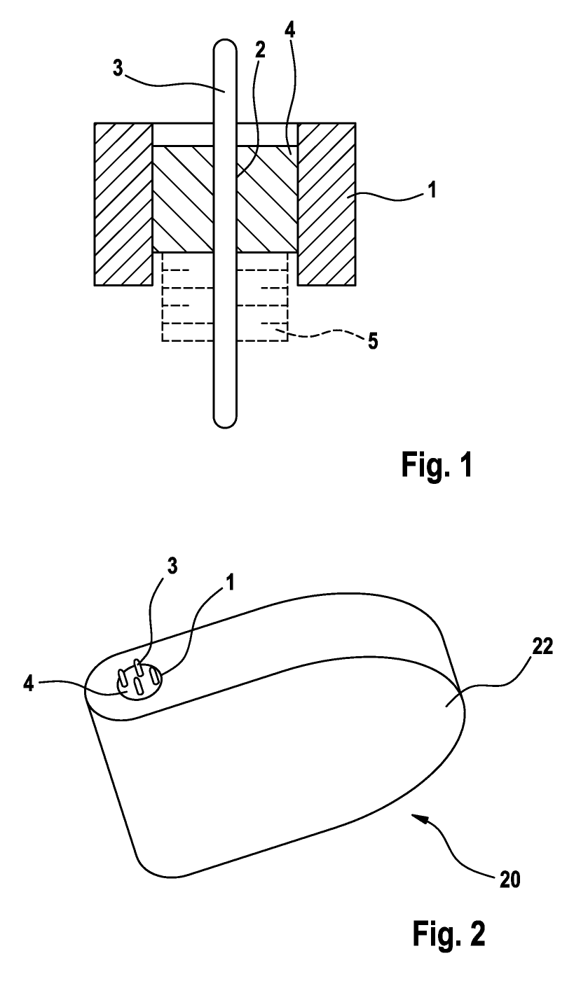

The bushing shown in FIG. 1 has a flange 1, which includes an insulation body 4. A terminal pin 3 passes through the insulation body 4. Instead of one terminal pin, in multipolar bushings, which are not shown here, multiple terminal pins may also be provided, which preferably project through the insulation body 4 parallel to one another.

In addition, a filter body 5 may be provided, which acts as a capacitor between the flange 1 and the terminal pin 3 and in this way acts as a low-pass filter, because high-frequency interference is short-circuited using the filter body. For this purpose, the filter body has electrodes which are each alternately connected to the flange and to the terminal pin using an electrically conductive connection material, such as an electrically conductive thermoplastic or an electrically conductive (metal) solder.

FIG. 1 shows an exemplary bushing, in which a terminal pin 3 and an insulation body 4 as well as a flange 1 are bonded to one another by sintering. The insulation body comprises an insulating material, such as a glass ceramic or ceramic, in particular Al₂O₃. The glass ceramic or the ceramic of the insulation body 4 is bonded hermetically sealed to the terminal pin 3 and the flange 1 due to the sintering process, so that any solder for sealing is obsolete. The terminal pin 3 comprises metal and may be produced from drawn solid material. The flange 1 itself may also be sintered. In this case, the flange 1 and insulator 4 are provided as a pressed, injection molded, or otherwise molded green product before the sintering process which bonds these components to one another.

The bond resulting due to the sintering process during bonding of the components is friction-locked as a result. The sintering process is preferably performed in such way that physical or chemical reactions which have a favorable effect on the long-term stability and the hermetic seal of the bushing occur at the interface between the components, in particular at the interface between terminal pin 3 and insulation body 4 on one hand and the interface between insulation body 4 and flange 1 on the other hand. An advantage of this production process is that no further following processes are needed. An advantage of the bushing produced in this way is that it is particularly tight and stable for a long time.

Preparation of the Interfaces, for Example, by Coating or in Another Way, is Typically not necessary.

As indicated by dashed lines in FIG. 1, the bushing may optionally have a filter 5.

Finally, FIG. 2 shows an example of a cardiac pacemaker 20, whose metallic housing is already closed using a filter bushing of the type shown in FIG. 1. For the sake of simplicity, the typical header of a cardiac pacemaker, in which the terminal sockets for the electrode lines are located, is not shown in FIG. 2. The electrical contacts of these terminal sockets are electrically connected to the pins 3 of the filter bushing in the finished cardiac pacemaker. The filter bushing—more precisely its flange 1—is connected hermetically sealed to the housing 22 of the cardiac pacemaker 20, preferably by welding. Therefore, it is advantageous if the flange 1 of the filter bushing comprises the same material as the housing 22 of the cardiac pacemaker 20.

What is claimed is:

1. An electrical feed through for insertion into an opening of an implantable electrical treatment device having an insulation body (4; 5) that is electrically insulating, through which at least one terminal pin (3) that is electrically conductive passes, which is connected hermetically sealed to said insulation body (4; 5), wherein insulation body (4) and at least one terminal pin (3) are bonded to one another by a sintering process.

2. The feed through according to claim 1, wherein said feed through has a flange (1), which is connected hermetically sealed in a sintering process to said insulation body (4) and said at least one terminal pin (3).

3. The feed through according to claim 1, wherein said insulation body (4) comprises ceramic, glass-ceramic, or glass-like material.

4. The feed through according to claim 3, wherein said insulation body (4) is a ceramic body containing Al₂O₃.

5. The feed through according to claim 1, wherein said at least one terminal pin (3) comprises metal.

6. The feed through according to claim 5, wherein metal of said terminal pin (3) is a metal selected from the group platinum, iridium, niobium, tantalum, and titanium or an alloy of these metals.

7. The feed through according to claim 6, wherein said metal of said at least one terminal pin (3) is a platinum-iridium alloy.

8. The feed through according to claim 1 further comprising a bushing configured with two or more terminal pins (3) of different lengths.

9. The feed through according to claim 1, further comprising a bushing configured with two or more terminal pins (3) running parallel to one another.

10. The feed through according to claim 9, wherein said two or more terminal pins (3) are distributed uniformly on a circular arc running concentrically to said insulation body (4).

11. The feed through according to claim 10, wherein said two or more terminal pins (3) are distributed uniformly on a straight line or multiple straight lines running parallel to one another.

12. The feed through according to claim 1, wherein a cross-sectional area of said insulation body (4) running perpendicularly to a longitudinal direction of said at least one terminal pin (3) is round.

13. The feed through according to claim 2, wherein said flange (1) is implemented as sleeve-like and encloses said insulation body (4) in relation to a longitudinal direction of said at least one terminal pin (3).

14. The feed through according to claim 2, wherein said flange (1) is metallically conductive.

15. The feed through according to claim 14, wherein said flange (1) comprises a metal, which extensively corresponds to metal of a housing of a treatment device for which said feed through is intended.

16. The feed through according to claim 14, wherein said flange (1) comprises sintered material which contains numerous pores as a result of said sintering process.

17. The feed through according to claim 14, wherein said feed through is implemented as a filter bushing and carries a filter body (5), which has capacitor electrode disks (22, 27), which are alternately electrically connected to said flange (1) and said at least one of terminal pin (3).

18. The feed through according to claim 1, wherein said insulation body (4) has a peripheral shoulder (18) in an external peripheral surface.

19. The feed through according to claim 18, wherein said peripheral shoulder (18) is implemented inclined.

20. The feed through according to claim 19, wherein said peripheral inclined shoulder (18) of said insulation body (4) has a corresponding shoulder (19) on said flange (1) as a centering aid.

21. The feed through according to claim 20, wherein said shoulder (19) on said flange (1) used as a centering aid for said insulation body (4) is implemented inclined matching said inclined shoulder (18) of said insulation body (4).

22. The feed through according to claim 1 further coupled with an implantable electrotherapy device, a cardiac pacemaker or cardioverter/defibrillator.
